(19) United States
(12) Patent Application Publication
(10) Pub. No.: US 2015/0201794 A1
(43) Pub. Date: Jul. 23, 2015

(54) Soda water producing device

(71) Applicant: GLOBAL REGENCY LIMITED, Kowloon (HK)

(72) Inventor: David Hoffmann, Kowloon (HK)

(73) Assignee: GLOBAL REGENCY LIMITED, Kowloon (HK)

(21) Appl. No.: 14/576,228

(22) Filed: Dec. 19, 2014

(30) Foreign Application Priority Data
Jan. 20, 2014 (CN) 201420036112.8

(51) Int. Cl. A47J 31/44; A23L 2/54; B01F 3/04

(52) U.S. Cl. CPC A47J 31/44; B01F 3/04794; A23L 2/54; B01F 2215/008

(57) ABSTRACT

A soda water producing device includes: a body; a cap; a bottle; a container inlet provided on a shell of the body for containing a CO₂ gas bottle; a rotary cover; a gas passage device; a gas bottle fixing device; a valve device; and a gas bottle unsealing needle mounted inside the gas bottle fixing device, wherein the gas bottle unsealing needle has an axial hole; wherein the rotary cover is mounted at a top portion of the body and is relatively rotatable; the valve device is mounted in the rotary cover; the gas bottle unsealing needle is mounted on a top end of the gas bottle fixing device and inside a bottom portion of the valve device; a top end of the gas passage device is movably mounted in the valve device, a bottom end of the gas passage device is mounted in a bottom portion of the body.

### CROSS REFERENCE OF RELATED APPLICATION

The present invention claims priority under 35 U.S.C. 119(a-d) to CN, filed.

### BACKGROUND OF THE PRESENT INVENTION

1. Field of Invention

The present invention relates to a soda water producing device, wherein an inflatable body and a cap thereof are detachable, the inflatable body is chargeable and is able to inject gas when being combined with the cap, and the soda water producing device is able to inject gas for many times.

2. Description of Related Arts

The conventional soda water producing device adopts an integrated structure, wherein a top thereof is sealed, and a bottom thereof is firmly connected to a bottle. A CO₂ gas bottle is placed in a top structure of the conventional soda water producing device with an outlet thereof facing downwards. During utilization, a needle mounted on a top portion of a cap on the bottle pierces through a sealer of the CO₂ gas bottle, in such a manner that CO₂ gas is injected into the bottle with water through a tube at a joint of the cap and the bottle. However, after the CO₂ gas bottle is unsealed, liquid CO₂ is instantly transformed into CO₂ gas and moves upwards (namely evaporation), and ices at the outlet. As a result, the outlet may be blocked, which will lead to an explosion of the CO₂ gas bottle. Therefore, hidden danger exists.

### SUMMARY OF THE PRESENT INVENTION

An object of the present invention is to provide a soda water producing device, wherein a CO₂ gas bottle is placed with an outlet thereof facing upwards, and CO₂ gas is injected into a drink bottle through a gas tunnel; when the CO₂ gas bottle is unsealed, liquid CO₂ is instantly transformed into CO₂ gas and moves upwards, in such a manner that the outlet is prevented from icing, which eliminates hidden danger.

Accordingly, in order to accomplish the above object, the present invention provides a soda water producing device, comprising:
a body; a cap; a bottle; a container inlet provided on a shell of the body for containing a CO₂ gas bottle; a rotary cover; a gas passage device; a gas bottle fixing device; a valve device; and a gas bottle unsealing needle mounted inside the gas bottle fixing device, wherein the gas bottle unsealing needle has an axial hole;
wherein the rotary cover is mounted at a top portion of the body and is relatively rotatable; the valve device is mounted in the rotary cover; the gas bottle unsealing needle is mounted on a top end of the gas bottle fixing device and inside a bottom portion of the valve device; a top end of the gas passage device is movably mounted in the valve device, a bottom end of the gas passage device is mounted in a bottom portion of the body; during utilization, the CO₂ gas bottle is placed in the gas bottle fixing device with an outlet thereof facing upwards; then the rotary cover and the body relatively rotate tight, in such a manner that the gas bottle unsealing needle pierces through the outlet of the CO₂ gas bottle; the gas passage device communicates with the gas bottle unsealing needle through a gas tunnel inside the valve device, in such a manner that the CO₂ gas bottle communicates with the gas tunnel inside the valve device and pushes a top portion of the gas passage device to move upwards until the gas passage device communicates with the gas tunnel of the valve device.

Preferably, the soda water producing device further comprises:
a rubber sleeve cased around the rotary cover;
two pull rods, wherein a top end of the pull rod is placed inside the valve device, and a bottom end of the pull rod is placed inside the body; and
a fixing ring mounted in the rotary cover, wherein the fixing ring forms a ring-shape gap with the rotary cover; a ring-shape convex portion on an external surface at a top portion of the valve device is placed in the gap.

Preferably, the soda water producing device further comprises: a gas gauge and a gas bottle detaching device, wherein a bottom portion of the gas gauge is mounted in the top portion of the valve device and communicates with the gas tunnel; the gas bottle unsealing needle communicates with the gas gauge through the gas tunnel in the valve device; the gas bottle detaching device is rotatably connected to the body, and a connecting joint thereof is inside the body; a side surface at a bottom end of the gas bottle detaching device extends out of the body.

Preferably, the valve device comprises:
the gas tunnel;
a longitudinal through-hole for containing the top portion of the gas passage device;
a first containing portion mounted at the bottom portion of the gas gauge; and
a second containing portion mounted at a top portion of the gas bottle fixing device;
wherein the gas tunnel, the longitudinal through-hole, the first containing portion and the second containing portion communicate with each other; the gas bottle unsealing needle is placed in the second containing portion; an end of the gas tunnel is placed on an external surface of the body with a sealing screw, a sealing ring is cased around the sealing screw.

Preferably, the gas gauge comprises: a dial cap, a dial, a hollow dial screw, a dial spring, an upper dial sealing ring, a lower dial sealing ring, a dial valve needle, and a dial screw sealer; wherein a bottom end of the dial cap is embedded in a top portion of the rotary cover, and a top portion of the dial cap is out of a top surface of the rotary cover; the dial cap comprises an extended portion which is out of the rotary cover, a top portion of the extended portion is non-transparent, and a bottom portion of the extended portion is transparent; a top portion of the dial valve needle extends out of a top surface of the hollow dial screw along an axial direction of the hollow dial screw; the dial is mounted on the top portion of the dial valve needle and is in the dial cap; an external surface of the dial axially comprises two layers with different colors; a bottom portion of the hollow dial screw is mounted in the first containing portion, the dial screw sealer is mounted on a bottom surface of the hollow dial screw, and a bottom surface of the dial valve needle contacts with the dial screw sealer for preventing the dial valve needle from detaching; a joint portion of the dial valve needle is inside the hollow dial screw, the joint portion has an upper ring slot and a lower ring slot for respectively embedding the upper dial sealing ring and the lower dial sealing ring, a top end of the dial spring cased on the joint portion presses against an internal surface at a top end of the hollow dial screw, and a bottom end of the dial spring presser against a top surface of the lower ring slot.

Preferably, the gas passage device comprises:
a piston movably provided in the longitudinal through-hole;
an upper piston sealing ring, a middle piston sealing ring, a lower piston sealing ring and a spring cased around the piston;
a gas tube;
a circlip and a gas tube upper sealer mounted at a top portion of the gas tube;
a gas tube lower sealer and a nozzle mounted at a bottom portion of the gas tube; and
a nozzle sealer mounted on the nozzle;
wherein an anti-drop screw is mounted on a top end of the piston, a loop is provided on a nut of the anti-drop screw along a radial direction of the nut, the loop is placed on a bottom surface of a concave holder which is mounted in a top surface of the valve device; a containing portion for containing a top portion of the gas tube and a gas passage communicating with the containing portion are mounted in a bottom portion of the piston, an opening of the gas passage is placed on an external surface of the piston; a bottom containing portion is provided at a bottom portion of the longitudinal through-hole, in such a manner that a bottom end of the piston moves up and down; an upper step surface and a lower step surface are provided at an external surface of the bottom portion of the piston, a bottom portion of the spring contacts with the lower step surface, a top portion of the spring contacts with a top surface of the lower containing portion; the upper piston sealing ring, the middle piston sealing ring, and the lower piston sealing ring embedded around the piston are above the spring; during utilization, the gas tube moves upwards for pushing and moving the piston upwards; when the upper step surface on the piston contacts with the top surface of the lower containing portion, the piston stops, and the opening of the gas passage, which is on the external surface of the piston, communicates with a opening of the gas tunnel on an internal surface of the longitudinal through-hole.

Preferably, the gas bottle fixing device comprises: a CO₂ gas bottle sealer, a main valve screw which is hollowed, a left supporter, and a right supporter; wherein a top portion of the gas bottle unsealing needle is mounted in the valve device, the CO₂ gas bottle sealer is cased around the gas bottle unsealing needle for being mounted on the main valve screw with the gas bottle unsealing needle, and a bottom end of the gas bottle unsealing needle is placed in a containing chamber of the main valve screw which contains a top portion of the CO₂ gas bottle; the main valve screw is mounted in the second containing portion; the axial hole of the gas bottle unsealing needle communicates with the gas tunnel; the right supporter is mounted in the body, the right supporter has a hole in such a manner that the gas tube passes through the hole.

Preferably, two connecting columns are respectively mounted on two side external surfaces at a front end of the right supporter, the left supporter has two connecting holes corresponding to the connecting columns and respectively provided on two side surfaces of the left supporter; the left supporter is connected to the right supporter before being cased around the CO₂ gas bottle, and the left supporter and the right supporter are relatively rotatable.

Preferably, the soda water producing device further comprises: a gas bottle case for containing the CO₂ gas bottle; wherein the CO₂ gas bottle is 8 g, 12 g or 16 g, and is placed in the gas bottle case which is corresponding to the CO₂ gas bottle.

Preferably, the gas bottle detaching device comprises: a handle, a button, a button spring, and a rotation shaft; wherein the handle comprises: a bottom plate, a paddle and a spring column formed together, the handle is connected to the button through the rotation shaft mounted in the body; the button spring is cased around the spring column and one end of the button spring contacts with an internal surface of the button; the paddle contacts with a bottom of the CO₂ gas bottle or the gas bottle case; a front end of the button is out of the body, and the button is below a side of the paddle.

Preferably, the body has a chamber at the bottom portion thereof, a shape of the chamber is corresponding to a shape of the cap for combining the chamber with the cap; during utilization, the body is pressed towards a top end of the cap, in such a manner that the chamber is combined with but not connected to the cap; then the nozzle in the gas passage device contacts with the top end of the cap for pushing and moving the gas tube upwards, so as to push and move the piston upwards, until the opening of the gas passage, which is on the external surface of the piston, communicates with the opening of the gas tunnel on the internal surface of the longitudinal through-hole, in such a manner that the cap communicates with the CO₂ gas bottle through the gas tunnel.

Therefore, after the CO₂ gas bottle is installed into the body, the gas bottle unsealing needle with the axial hole pierces through and seals the outlet of the CO₂ gas bottle, CO₂ gas enters the gas tunnel in the valve device through the axial hole, so as to enter the first containing portion for pushing and moving the dial valve needle upwards. The dial moves upwards with the dial valve needle. If a colored area on the dial is visible from the transparent portion of the dial cap, the CO₂ in the CO₂ gas bottle is not enough and the CO₂ gas bottle should be replaced. Otherwise, the CO₂ gas bottle should not be replaced. The shape of the chamber at the bottom portion of the body is corresponding to a shape of the cap for combining the chamber with the cap. Initially, the opening of the gas passage on the piston of the gas passage device does not communicate with the opening of the gas passage which is on the internal surface of the longitudinal through-hole. During utilization, the body is pressed towards the top end of the cap, in such a manner that the chamber is combined with but not connected to the cap; then the nozzle in the gas passage device contacts with the top end of the cap for pushing and moving the gas tube upwards, so as to push and move the piston upwards, until the opening of the gas passage, which is on the external surface of the piston, communicates with the opening of the gas tunnel on the internal surface of the longitudinal through-hole. The piston stops, and the cap communicates with the CO₂ gas bottle through the gas tunnel. The CO₂ gas enters the cap through the gas tunnel for entering the bottle, which is repeatable for injecting gas many times. For detaching the CO₂ gas bottle, the rotary cover is rotated, in such a manner that the rotary cover is lifted relative to the body. Then the button is pressed for pushing the handle to rotate, in such a manner that the paddle on the handle pushes a bottom of the CO₂ gas bottle or the gas bottle case out of the body. Then the CO₂ gas bottle is detached and the rotary cover is tightened. Compared with the conventional technology, the outlet of the CO₂ gas bottle faces upwards. When the CO₂ gas bottle is unsealed, liquid CO₂ is instantly transformed into the CO₂ gas and moves upwards, in such a manner that the outlet is prevented from icing, which eliminates hidden danger. Furthermore, the CO₂ gas bottle is easy to be attached and detached.

### BRIEF DESCRIPTION OF THE DRAWINGS

FIG. 1a is an exploded view of an upper portion of a soda water producing device according to a preferred embodiment of the present invention.

FIG. 1b is an exploded view of a lower portion of the soda water producing device according to the preferred embodiment of the present invention.

FIG. 2 is a sketch view of CO₂ gas bottle installation according to the preferred embodiment of the present invention.

FIG. 3 is a sketch view of the soda water producing device with the CO₂ gas bottle according to the preferred embodiment of the present invention.

FIG. 4 is a sketch view of the soda water producing device during utilization according to the preferred embodiment of the present invention.

FIG. 5 is a sketch view of detaching the CO₂ gas bottle according to the preferred embodiment of the present invention.

FIG. 6 is a sketch view of the soda water producing device without the CO₂ gas bottle according to the preferred embodiment of the present invention.

### DETAILED DESCRIPTION OF THE PREFERRED EMBODIMENT

These and other objectives, features, and advantages of the present invention will become apparent from the following detailed description, the accompanying drawings, and the appended claims.

According to the present invention, a cap is combined. Structures of the cap and a bottle are described in Chinese patent CN201220510466.2, and details thereof will not be described.

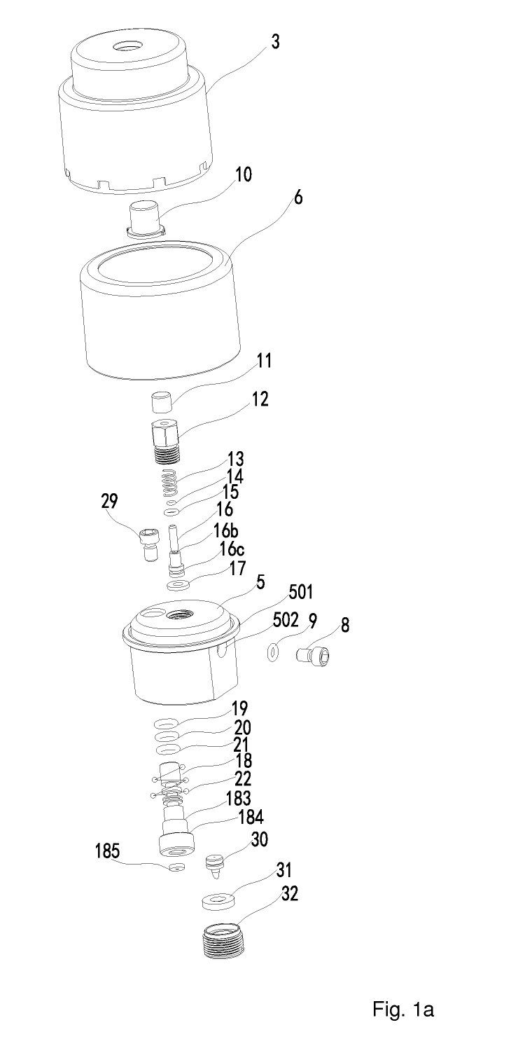

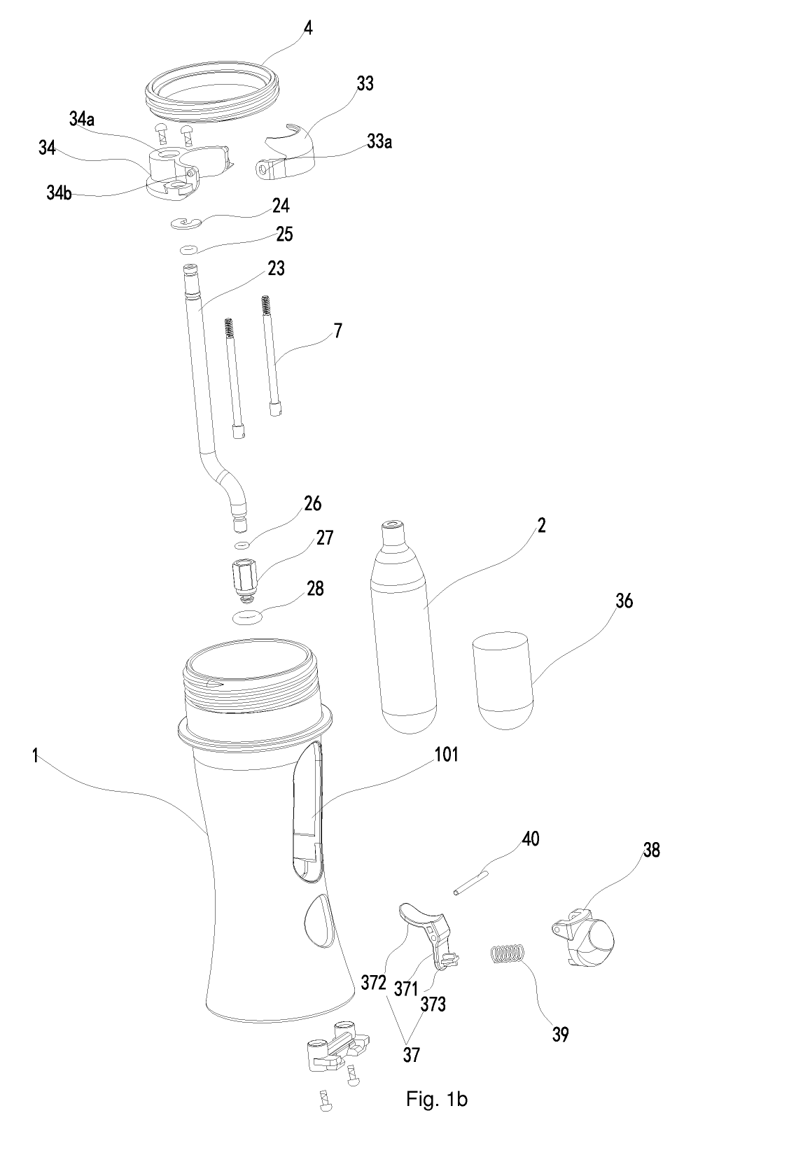

Referring to FIGS. 1a, 1b, 2 and 3 of the drawings, a soda water producing device according to a preferred embodiment of the present invention is illustrated, comprising:

a body 1, wherein a CO₂ gas bottle 2 is detachably mounted in the body 1; a container inlet 101 provided on a shell of the body for containing the CO₂ gas bottle 2; a rotary cover 3; a gas gauge; a gas passage device; a gas bottle fixing device; a fixing ring 4; a valve device 5; a gas bottle detaching device; a rubber sleeve 6 cased around the rotary cover 3; and two pull rods 7, wherein a top end of the pull rod 7 is placed inside the valve device 5, and a bottom end of the pull rod 7 is placed inside a ring chamber of the body.

The rotary cover 3 covers a top portion of the body 1 and is connected to the body 1 through a screw thread, in such a manner that the rotary cover 3 is relatively rotatable but not detachable. The fixing ring 4 is embedded in the rotary cover 3. A ring-shape convex portion 501 is provided on the valve device 5. The ring-shape convex portion 501 is embedded in a ring-shape gap at a joint of the fixing ring 4 and the rotary cover 3, for mounting the valve device 5, and a top end of the valve device 5 is provided in the rotary cover 3.

The valve device 5 comprises:
a gas tunnel 502 provided therein;
a longitudinal through-hole 503 for containing a top portion of the gas passage device;
a first containing portion 504 mounted at a bottom portion of the gas gauge; and
a second containing portion 505 mounted at a top portion of the gas bottle fixing device;
wherein the gas tunnel 502, the longitudinal through-hole 503, the first containing portion 504 and the second containing portion 505 communicate with each other; for processing convenience, the gas tunnel 502 is drilled on the valve body 5; therefore, an end of the gas tunnel 502 is placed on an external surface of the body with a sealing screw 8, and a sealing ring 9 is cased around the sealing screw 8.

When the valve device 5 enters the body 1 with the rotary cover 3, the pull rods 7 firstly enter the ring chamber of the body 1 for ensuring that the valve device 5 reaches a pre-determined position in the body 1. During tightening the rotary cover 3 relative to the body 1, the valve device 5 does not rotate, but only moves up and down relative to the body 1.

The gas gauge comprises: a dial cap 10, a dial 11, a hollow dial screw 12, a dial spring 13, an upper dial sealing ring 14, a lower dial sealing ring 15, a dial valve needle 16, and a dial screw sealer 17; wherein a bottom end of the dial cap 10 is embedded in a top portion of the rotary cover 3, and a top portion of the dial cap 10 is out of a top surface of the rotary cover 3; the dial cap 10 comprises an extended portion which is out of the rotary cover 3, a top portion 10a of the extended portion is non-transparent, and a bottom portion 10b of the extended portion is transparent; a top portion of the dial valve needle 16 extends out of a top surface of the hollow dial screw 12 along an axial direction of the hollow dial screw 12; the dial 11 is provided on the top portion of the dial valve needle 16 and is in the dial cap 10. According to the preferred embodiment, an external surface of the dial axially comprises two layers with different colors. For example, an upper layer is colored red and a lower layer is colored blue. A bottom portion of the hollow dial screw 12 is mounted in the first containing portion 504, and a hollowed portion of the hollow dial screw 12 communicates with the first containing portion 504. The dial screw sealer 17 is mounted on a bottom surface of the hollow dial screw 12, and a bottom surface of the dial valve needle 16 contacts with the dial screw sealer 17 for preventing the dial valve needle 16 from detaching. A joint portion 16a of the dial valve needle 16 is inside the hollow dial screw 12, the joint portion 16a has an upper ring slot 16b and a lower ring slot 16c for respectively embedding the upper dial sealing ring 14 and the lower dial sealing ring 15. A top end of the dial spring 13 cased on the joint portion 16a presses against an internal surface at a top end of the hollow dial screw 12, and a bottom end of the dial spring 13 presser against a top surface of the lower ring slot 16c. A loop flange is mounted at the bottom end of the dial cap 10 along a radial direction of the dial cap 10, and the dial cap 10 is mounted by another loop flange embedded in the top portion of the rotary portion 3.

The gas passage device comprises:
a piston 18 movably provided in the longitudinal through-hole 503;
an upper piston sealing ring 19, a middle piston sealing ring 20, a lower piston sealing ring 21 and a spring 22 cased around the piston 18;
a gas tube 23;
a circlip 24 and a gas tube upper sealer 25 mounted at a top portion of the gas tube 23;
a gas tube lower sealer 26 and a nozzle 27 mounted at a bottom portion of the gas tube 23; and
a nozzle sealer 28 mounted on the nozzle 27;
wherein an anti-drop screw 29 is mounted on a top end of the piston 18, a loop 29a is provided on a nut of the anti-drop screw 29 along a radial direction of the nut, the loop 29a is placed on a bottom surface of a concave holder 506 which is mounted in a top surface of the valve device 5; a containing portion 181 for containing a top portion of the gas tube 23 and a gas passage 182 communicating with the containing portion 181 are mounted in a bottom portion of the piston 18, an opening 182a of the gas passage is placed on an external surface of the piston 18; a bottom containing portion 503a is provided at a bottom portion of the longitudinal through-hole 503, in such a manner that a bottom end of the piston 18 moves up and down; an upper step surface 183 and a lower step surface 184 are provided at an external surface of the bottom portion of the piston 18, a bottom portion of the spring 22 contacts with the lower step surface 184, a top portion of the spring 22 contacts with a top surface of the lower containing portion 503a; the upper piston sealing ring 19, the middle piston sealing ring 20, and the lower piston sealing ring 21 embedded around the piston 18 are above the spring 22; a piston sealer 185 is mounted at the bottom end of the piston 18.

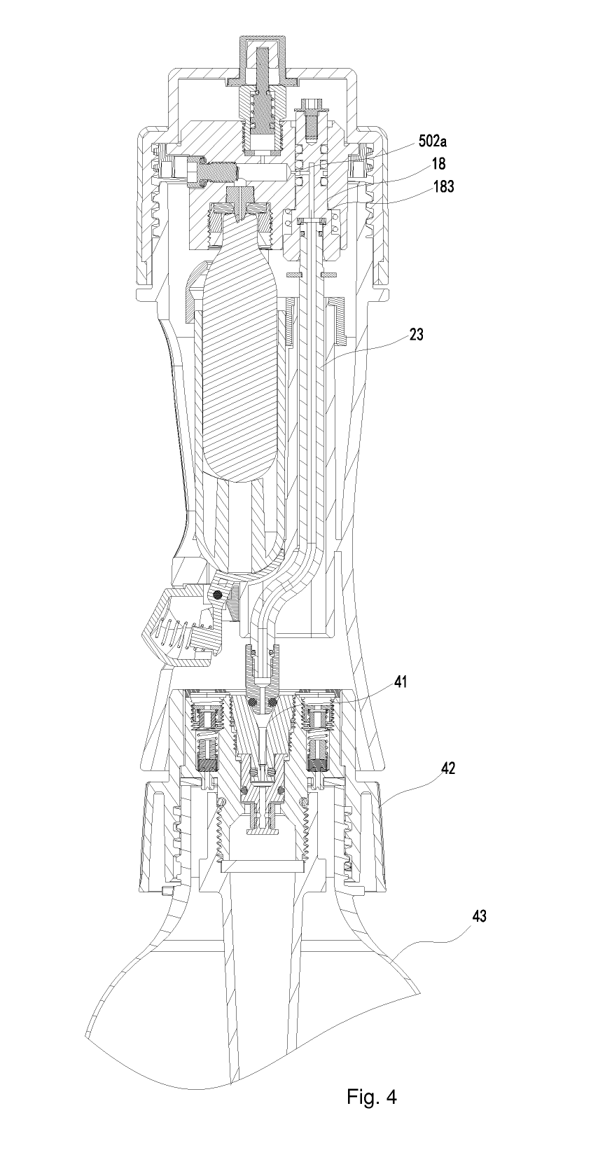

Referring to FIG. 4 of the drawings, the body 1 has a chamber at the bottom portion thereof, and a shape of the chamber is corresponding to a top end shape of a cap 42 for combining the chamber with the cap 42. During utilization, the body 1 is pressed towards a top end of the cap 42, in such a manner that the chamber is combined with but not connected to the cap 42. That is to say, the body 1 and the cap 42 are not connected by a fixer or a screw thread, and are able to be attached or detached at any time. Then the nozzle 27 in the gas passage device contacts with a main valve guiding screw 41 at the top end of the cap 42, and a bottom end of the nozzle 27 communicates with the main valve guiding screw 41 on the cap 42, for pushing and moving the gas tube 23 upwards, so as to push and move the piston 18 upwards, until the opening 182a of the gas passage 182, which is on the external surface of the piston 18, communicates with the opening 502a of the gas tunnel 502 on the internal surface of the longitudinal through-hole 503, in such a manner that the cap 42 communicates with the CO₂ gas bottle 2 through the gas tunnel 502. The CO₂ gas in the CO₂ gas bottle enters a bottle 43 through the cap 42, which is repeatable for injecting gas many times. The gas tube 23 pushes and moves the piston 18 upwards. The piston stops when the upper step surface 183 on the piston 18 contacts with a top surface of the lower containing portion 503a. The upper step surface 183 limits a position. At the same time, the opening 182a of the gas passage 182, which is on the external surface of the piston 18, communicates with the opening 502a of the gas tunnel 502 on the internal surface of the longitudinal through-hole 503.

Referring to FIGS. 1a, 1b, 2 and 3 of the drawings, the gas bottle fixing device comprises: a gas bottle unsealing needle 30 with an axial hole 301, a CO₂ gas bottle sealer 31, a main valve screw 32 which is hollowed, a left supporter 33, and a right supporter 34; wherein a top portion of the gas bottle unsealing needle 30 is mounted in the valve device 5, the CO₂ gas bottle sealer 31 is cased around the gas bottle unsealing needle 30 for being mounted on the main valve screw 32 with the gas bottle unsealing needle 30, and a bottom end of the gas bottle unsealing needle 30 is placed in a containing chamber of the main valve screw 32 which contains a top portion and the outlet of the CO₂ gas bottle 2; the main valve screw 32 is mounted in the second containing portion 505; the axial hole 301 of the gas bottle unsealing needle 30 communicates with the gas tunnel 502; the right supporter 34 is mounted in the body, the right supporter 34 has a hole 34a in such a manner that the gas tube 23 passes through the hole 34a; after the CO₂ gas bottle 2 is installed, the rotary cover 3 is rotated tight; and the gas bottle unsealing needle 30 pierces through the outlet of the CO₂ gas bottle 2, in such a manner that the CO₂ gas enters the gas tunnel 502 through the axial hole 301.

Two connecting columns 34b are respectively mounted on two side external surfaces at a front end of the right supporter 34, the left supporter 33 has two connecting holes 33a corresponding to the connecting columns and respectively provided on two side surfaces of the left supporter 33; the left supporter 33 is connected to the right supporter 34 before being cased around the CO₂ gas bottle 2, and the left supporter 33 and the right supporter 34 are relatively rotatable.

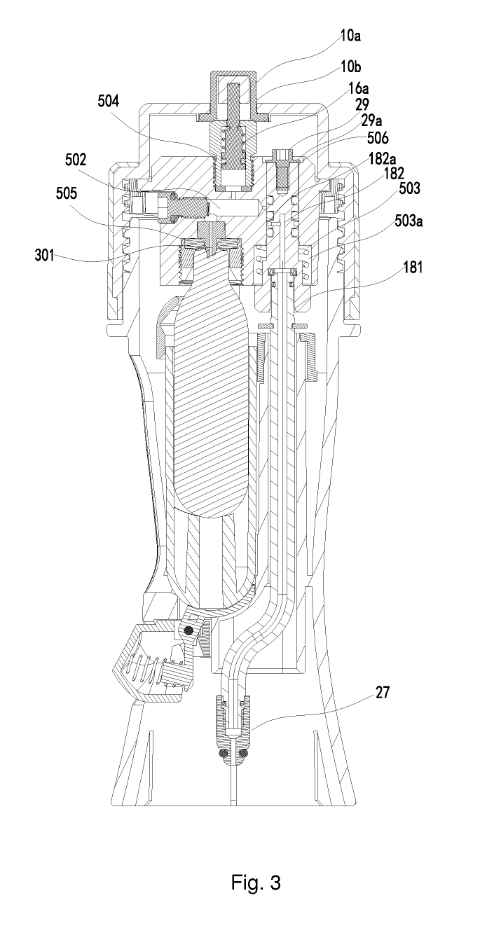

Referring to the FIG. 3 of the drawings, when the CO₂ gas bottle is unsealed, the CO₂ gas enters the gas tunnel 502, and then enters the hollow portion of the hollow dial screw 12 communicating with the first containing portion 504. The CO₂ gas pushes the bottom end of the dial valve needle 16 for moving the dial valve needle 16 upwards, in such a manner that the dial 11 moves upwards in the dial cap 10. If the blue area of the dial 11 is visible from the transparent portion of the dial cap 10, a gas pressure in the valve device 5 is enough. Otherwise, if the gas pressure is not enough, the dial valve needle 16 moves downwards. Then the dial 11 moves downwards, and the red area of the dial 11 is visible from the transparent portion of the dial cap 10, which illustrates that the gas pressure in the valve device 5 is not enough, and the CO₂ gas bottle 2 should be replaced.

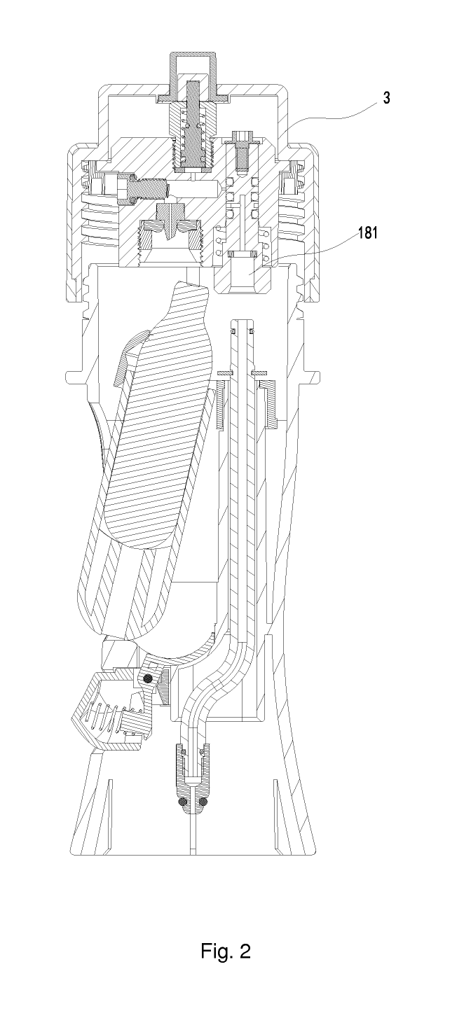

Referring to the FIG. 2 of the drawings, the CO₂ gas bottle 2 is not installed, and the CO₂ gas does not enter the gas tunnel 502. Therefore, no CO₂ gas enter the first containing portion which communicates with the gas tunnel 502, and the dial valve needle 16 is not pushed upwards to contact with the dial screw sealer 17. Referring to FIGS. 3˜4 of the drawings, after the CO₂ gas bottle 2 is installed, the rotary cover 3 is rotated tight, in such a manner that the CO₂ gas bottle is unsealed; the CO₂ gas enters the gas tunnel 502, and then enters the hollow portion of the hollow dial screw 12 communicating with the first containing portion 504. The CO₂ gas pushes the bottom end of the dial valve needle 16 for moving the dial valve needle 16 upwards, in such a manner that the dial 11 moves upwards in the dial cap 10, and the dial valve needle 16 is separated from the dial screw sealer 17.

According to the present invention, different CO₂ gas bottles 2 are applicable. According to the preferred embodiment, the CO₂ gas bottle 2 is 8 g, 12 g or 16 g. 8 g and 12 g CO₂ gas bottles 2 should be placed in the gas bottle case 36 which is corresponding to the CO₂ gas bottle. 16 g CO₂ gas bottle is directly installed into the gas bottle fixing device without the gas bottle case 36.

Referring to FIGS. 1a, 1b, 2 and 3 of the drawings, the gas bottle detaching device comprises: a handle 37, a button 38, a button spring 39, and a rotation shaft 40; wherein the handle 37 comprises: a bottom plate 371, a paddle 372 and a spring column 373 formed together; the spring column 373 is vertically mounted on an internal surface of the bottom plate 371; the handle 37 is connected to the button 38 through the rotation shaft 40 mounted in the body 1; the button spring 39 is cased around the spring column 373 and one end of the button spring 39 contacts with an internal surface of the button 38; the paddle 372 contacts with a bottom of the CO₂ gas bottle 2 or the gas bottle case 36; a front end of the button 38 is out of the body 1, and the button 38 is below a side of the paddle 372.

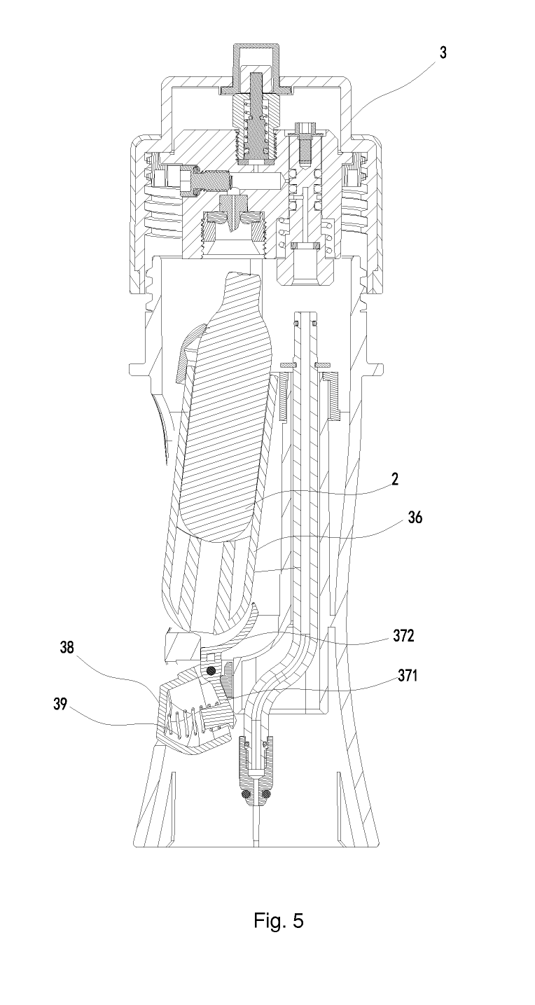

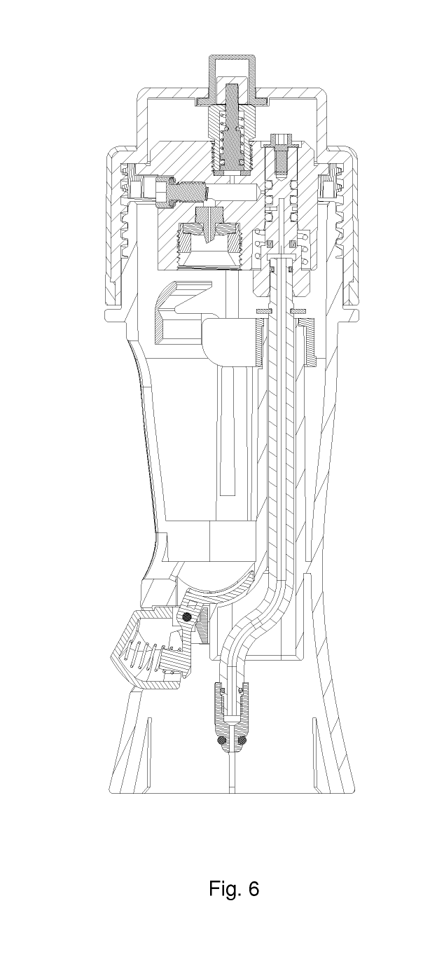

Referring to FIG. 5 of the drawings, for detaching the CO₂ gas bottle 2, the rotary cover 3 is loosened. Then the button 38 is pressed, in such a manner that the button 38 pushes the bottom plate 371 to rotate, and the bottom plate 371 drives the paddle 372 to rotate. As a result, the paddle 372 pushes a bottom of the CO₂ gas bottle 2 or the gas bottle case 36 out of the body 1. Then the CO₂ gas bottle 2 is detached and the button 38 is loosened. Referring to FIG. 6 of the drawings, the soda water producing device without the CO₂ gas bottle 2 is illustrated. The button spring protects the handle 37. For example, when the CO₂ gas bottle 2 is installed and fixed and the button 38 is accidentally pressed, the button 38 is prevented from directly contacting with the handle 37 due to buffer of the button spring 39, in such a manner that the handle 37 is not damaged.

Referring to FIG. 2 of the drawings, for installing the CO₂ gas bottle 2, the rotary cover is loosened, and the CO₂ gas bottle 2 is placed and pushed into the body 1 through the container inlet 101 of the body 1. Then the rotary cover 3 is rotated tight. By appropriately tightening the rotary cover 3, the bottom end of the gas bottle unsealing needle 30 contacts with but does not pierce through the outlet of the CO₂ gas bottle 2, which is illustrated in FIG. 3.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A soda water producing device, comprising:
a body; a cap; a bottle; a container inlet provided on a shell of said body for containing a CO₂ gas bottle; a rotary cover; a gas passage device; a gas bottle fixing device; a valve device; and a gas bottle unsealing needle mounted inside said gas bottle fixing device, wherein said gas bottle unsealing needle has an axial hole;
wherein said rotary cover is mounted at a top portion of said body and is relatively rotatable; said valve device is mounted in said rotary cover; said gas bottle unsealing needle is mounted on a top end of said gas bottle fixing device and inside a bottom portion of said valve device; a top end of said gas passage device is movably mounted in said valve device, a bottom end of said gas passage device is mounted in a bottom portion of said body; during utilization, said CO₂ gas bottle is placed in said gas bottle fixing device with an outlet thereof facing upwards; then said rotary cover and said body relatively rotate tight, in such a manner that said gas bottle unsealing needle pierces through said outlet of said CO₂ gas bottle; said gas passage device communicates with said gas bottle unsealing needle through a gas tunnel inside said valve device, in such a manner that said CO₂ gas bottle communicates with said gas tunnel inside said valve device and pushes a top portion of said gas passage device to move upwards until said gas passage device communicates with said gas tunnel of said valve device.

2. The soda water producing device, as recited in claim 1, further comprising:
a rubber sleeve cased around said rotary cover;
two pull rods, wherein a top end of said pull rod is placed inside said valve device, and a bottom end of said pull rod is placed inside said body; and
a fixing ring mounted in said rotary cover, wherein said fixing ring forms a ring-shape gap with said rotary cover; a ring-shape convex portion on an external surface at a top portion of said valve device is placed in said gap.

3. The soda water producing device, as recited in claim 1, further comprising: a gas gauge and a gas bottle detaching device, wherein a bottom portion of said gas gauge is mounted in said top portion of said valve device and communicates with said gas tunnel; said gas bottle unsealing needle communicates with said gas gauge through said gas tunnel in said valve device; said gas bottle detaching device is rotatably connected to said body, and a connecting joint thereof is inside said body; a side surface at a bottom end of said gas bottle detaching device extends out of said body.

4. The soda water producing device, as recited in claim 3, wherein said valve device comprises:
said gas tunnel;
a longitudinal through-hole for containing said top portion of said gas passage device;
a first containing portion mounted at said bottom portion of said gas gauge; and
a second containing portion mounted at a top portion of said gas bottle fixing device;
wherein said gas tunnel, said longitudinal through-hole, said first containing portion and said second containing portion communicate with each other; said gas bottle unsealing needle is placed in said second containing portion; an end of said gas tunnel is placed on an external surface of said body with a sealing screw, a sealing ring is cased around said sealing screw.

5. The soda water producing device, as recited in claim 4, wherein said gas gauge comprises: a dial cap, a dial, a hollow dial screw, a dial spring, an upper dial sealing ring, a lower dial sealing ring, a dial valve needle, and a dial screw sealer; wherein a bottom end of said dial cap is embedded in a top portion of said rotary cover, and a top portion of said dial cap is out of a top surface of said rotary cover; said dial cap comprises an extended portion which is out of said rotary cover, a top portion of said extended portion is non-transparent, and a bottom portion of said extended portion is transparent; a top portion of said dial valve needle extends out of a top surface of said hollow dial screw along an axial direction of said hollow dial screw; said dial is mounted on said top portion of said dial valve needle and is in said dial cap; an external surface of said dial axially comprises two layers with different colors; a bottom portion of said hollow dial screw is mounted in said first containing portion, said dial screw sealer is mounted on a bottom surface of said hollow dial screw, and a bottom surface of said dial valve needle contacts with said dial screw sealer for preventing said dial valve needle from detaching; a joint portion of said dial valve needle is inside said hollow dial screw, said joint portion has an upper ring slot and a lower ring slot for respectively embedding said upper dial sealing ring and said lower dial sealing ring, a top end of said dial spring cased on said joint portion presses against an internal surface at a top end of said hollow dial screw, and a bottom end of said dial spring presser against a top surface of said lower ring slot.

6. The soda water producing device, as recited in claim 4, wherein said gas passage device comprises:
a piston movably provided in said longitudinal through-hole;
an upper piston sealing ring, a middle piston sealing ring, a lower piston sealing ring and a spring cased around said piston;
a gas tube;
a circlip and a gas tube upper sealer mounted at a top portion of said gas tube;
a gas tube lower sealer and a nozzle mounted at a bottom portion of said gas tube; and
a nozzle sealer mounted on said nozzle;
wherein an anti-drop screw is mounted on a top end of said piston, a loop is provided on a nut of said anti-drop screw along a radial direction of said nut, said loop is placed on a bottom surface of a concave holder which is mounted in a top surface of said valve device; a containing portion for containing a top portion of said gas tube and a gas passage communicating with said containing portion are mounted in a bottom portion of said piston, an opening of said gas passage is placed on an external surface of said piston; a bottom containing portion is provided at a bottom portion of said longitudinal through-hole, in such a manner that a bottom end of said piston moves up and down; an upper step surface and a lower step surface are provided at an external surface of said bottom portion of said piston, a bottom portion of said spring contacts with said lower step surface, a top portion of said spring contacts with a top surface of said lower containing portion; said upper piston sealing ring, said middle piston sealing ring, and said lower piston sealing ring embedded around said piston are above said spring; during utilization, said gas tube moves upwards for pushing and moving said piston upwards; when said upper step surface on said piston contacts with said top surface of said lower containing portion, said piston stops, and said opening of said gas passage, which is on said external surface of said piston, communicates with an opening of said gas tunnel on an internal surface of said longitudinal through-hole.

7. The soda water producing device, as recited in claim 4, wherein said gas bottle fixing device comprises: a CO₂ gas bottle sealer, a main valve screw which is hollowed, a left supporter, and a right supporter; wherein a top portion of said gas bottle unsealing needle is mounted in said valve device, said CO₂ gas bottle sealer is cased around said gas bottle unsealing needle for being mounted on said main valve screw with said gas bottle unsealing needle, and a bottom end of said gas bottle unsealing needle is placed in a containing chamber of said main valve screw which contains a top portion of said CO₂ gas bottle; said main valve screw is mounted in said second containing portion; said axial hole of said gas bottle unsealing needle communicates with said gas tunnel; said right supporter is mounted in said body, said right supporter has a hole in such a manner that said gas tube passes through said hole.

8. The soda water producing device, as recited in claim 7, wherein two connecting columns are respectively mounted on two side external surfaces at a front end of said right supporter, said left supporter has two connecting holes corresponding to said connecting columns and respectively provided on two side surfaces of said left supporter; said left supporter is connected to said right supporter before being cased around said CO₂ gas bottle, and said left supporter and said right supporter are relatively rotatable.

9. The soda water producing device, as recited in claim 7, further comprising a gas bottle case for containing said CO₂ gas bottle, wherein said CO₂ gas bottle is 8 g, 12 g or 16 g, and is placed in said gas bottle case which is corresponding to said CO₂ gas bottle.

10. The soda water producing device, as recited in claim 3, wherein said gas bottle detaching device comprises: a handle, a button, a button spring, and a rotation shaft; wherein said handle comprises: a bottom plate, a paddle and a spring column formed together, said handle is connected to said button through said rotation shaft mounted in said body; said button spring is cased around said spring column and one end of said button spring contacts with an internal surface of said button; said paddle contacts with a bottom of said CO₂ gas bottle or said gas bottle case; a front end of said button is out of said body, and said button is below a side of said paddle.

11. The soda water producing device, as recited in claim 6, wherein said body has a chamber at said bottom portion thereof, a shape of said chamber is corresponding to a shape of said cap for combining said chamber with said cap; during utilization, said body is pressed towards a top end of said cap, in such a manner that said chamber is combined with but not connected to said cap; then said nozzle in said gas passage device contacts with said top end of said cap for pushing and moving said gas tube upwards, so as to push and move said piston upwards, until said opening of said gas passage, which is on said external surface of said piston, communicates with said opening of said gas tunnel on said internal surface of said longitudinal through-hole, in such a manner that said cap communicates with said CO₂ gas bottle through said gas tunnel.
